(19) United States
(12) Patent Application Publication
(10) Pub. No.: US 2006/0273677 A1
(43) Pub. Date: Dec. 7, 2006

(54) Rotor for motor

(75) Inventors: Alex Horng, Kaohsiung (TW); Yin-Rong Hong, Kaohsiung (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung (TW)

(21) Appl. No.: 11/146,040

(22) Filed: Jun. 7, 2005

(51) Int. Cl. H02K 15/12; H02K 1/27

(52) U.S. Cl. 310/156.38; 310/44; 310/156.32

(57) ABSTRACT

A motor rotor includes a magnetic hub made of a plastic matrix and magnetic powders. At least one surface of the magnetic hub includes a plurality of alternately disposed north pole zones and south pole zones. A shaft includes an end fixed to a central portion of the magnetic hub. The structure of a motor using the rotor is simplified, the manufacturing process thereof is shortened, and the manufacturing cost thereof is cut. Further, the radial size and the axial size of the rotor can be reduced, which is advantageous to miniaturization of the motor using the rotor.

### BACKGROUND OF THE INVENTION

1. Field of the Invention

The present invention relates to a rotor. In particular, the present invention relates to a rotor for a motor.

2. Description of Related Art

FIG. 1 illustrates a conventional rotor for a motor. The rotor 10 comprises a hub 11 made of plastic material, a shaft 12 made of metal, an annular magnet 13 (such as a ferrite magnet, alnico magnet, or rubber magnet), and a magnetically conductive member 14 made of a magnetically conductive material such as iron. An end of the shaft 12 is fixed to a central portion of an end wall of the hub 11. The annular magnet 13 includes a plurality of alternately disposed north pole zones and south pole zones in an inner circumference thereof. In assembly, the magnetically conductive member 14 is mounted to an inner circumference of the hub 11, and the annular magnet 13 is then mounted to an inner circumference of the magnetically conductive member 14. The magnetically conductive member 14 prevents magnetic leakage of the annular magnet 13. The rotor 10 is mounted to a fixed portion 20 to form a miniature brushless D.C. motor.

Although the rotor 1 is widely used in motors for heat-dissipating fans and in spindle motors for optical disk drives, the following problems still exist. First, due to the trend of miniaturization in the design of heat-dissipating fans and spindle motors, it becomes more difficult to precisely manufacture or assemble the small parts of the rotor 1. Secondly, in a case that glue is used to bond the respective circumferences of the annular magnet 13, the magnetically conductive member 14, and the hub 11. Uneven application of the glue would result in uneven gaps between the annular magnet 13, the magnetically conductive member 14, and the hub 11. In another case that the annular magnet 13, the magnetically conductive member 14, and the hub 11 are engaged with each other by press-fitting, over-press-fitting would result in deformation of the annular magnet 13, the magnetically conductive member 14, and the hub 11. In either case, the weight distribution of the rotor in the circumferential direction is neither uniform nor symmetric, leading to adverse affect to the rotational stability of the motor and wear to the shaft 12.

### OBJECTS OF THE INVENTION

An object of the present invention is to provide a motor rotor with a simplified structure for obtaining a small-size motor rotor.

Another object of the present invention is to provide a motor rotor that can be used with stators for various types of motors, allowing flexible assembly.

### SUMMARY OF THE INVENTION

A motor rotor in accordance with the invention comprises a magnetic hub made of a plastic matrix and magnetic powders. The magnetic hub has a central portion. The magnetic hub further includes a plurality of surfaces. At least one of the surfaces of the magnetic hub includes a plurality of alternately disposed north pole zones and south pole zones. A shaft includes an end fixed to the central portion of the magnetic hub.

The structure of a motor using the rotor is simplified, the manufacturing process thereof is shortened, and the manufacturing cost thereof is cut. Further, the radial size and the axial size of the rotor can be reduced, which is advantageous to miniaturization of the motor using the rotor.

Preferably, the magnetic hub is formed by injection molding.

Preferably, the magnetic hub comprises an inner circumference that is radially magnetized to form the north pole zones and south pole zones. Alternatively, the magnetic hub comprises an outer circumference that is radially magnetized to form the north pole zones and south pole zones.

The magnetic hub may further comprise a plurality of integrally formed vanes for forming a heat-dissipating fan.

In a modified embodiment, the magnetic hub comprises an inner face that is axially magnetized to form the north pole zones and south pole zones. Alternatively, the magnetic hub comprises an outer face that is axially magnetized to form the north pole zones and south pole zones.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view, partly cutaway, of a motor with a conventional rotor.

FIG. 2 is a perspective view, partly cutaway, of a first embodiment of a rotor in accordance with the present invention;

FIG. 3 is a sectional view illustrating magnetization of the rotor in FIG. 2;

FIG. 4 is a sectional view of the rotor in FIG. 2, illustrating distribution of the north poles and the south poles;

FIG. 5 is a sectional view illustrating a motor comprising the rotor in FIG. 2;

FIG. 6 is a sectional view of a motor comprising a second embodiment of the rotor in accordance with the present invention; and

FIG. 7 is an exploded perspective view illustrating a motor comprising a third embodiment of the rotor in accordance with the present invention.

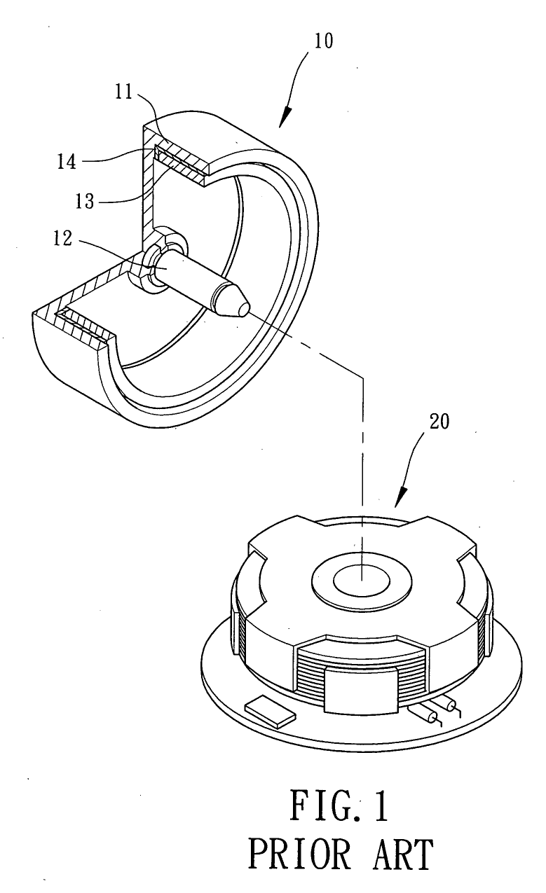

### DETAILED DESCRIPTION OF THE PREFERRED EMBODIMENTS

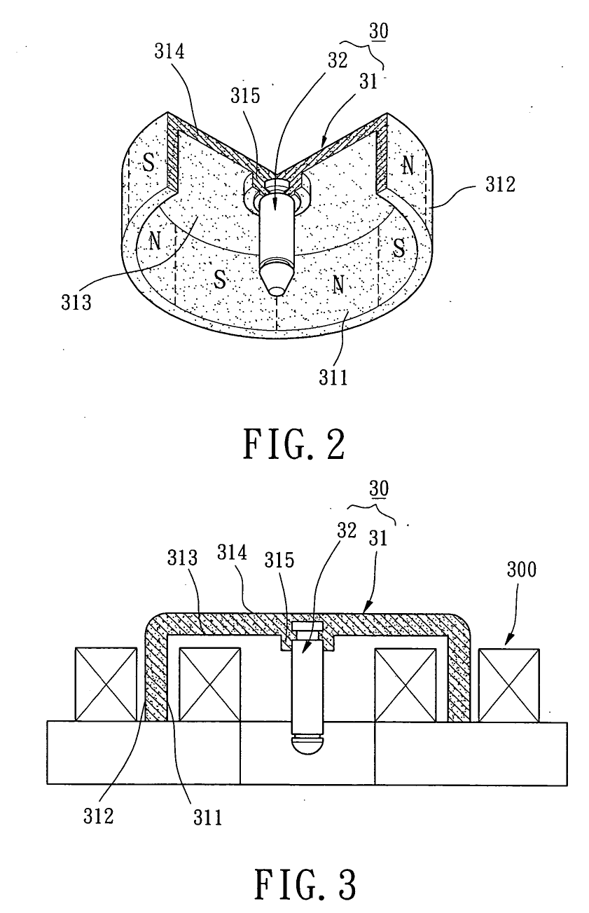

Referring to FIG. 2, a first embodiment of a rotor 30 in accordance with the present invention comprises a magnetic hub 31 and a shaft 32. The rotor 30 can be used in motors for heat-dissipating fans, spindle motors for optical disk drives, etc to simplify the rotor structure for these motors.

As illustrated in FIG. 2, the magnetic hub 31 is made of a plastic matrix and magnetic powders. In other words, the magnetic hub 31 is made of a plastic magnet. The plastic matrix is thermoplastic and has rigidity suitable for injection molding so as to obtain a pre-determined shape. Preferably, the plastic matrix is selected from thermoplastic plastics. Preferably, the magnetic powders are powders of magnetic materials or magnetically conductive materials. The magnetic hub 31 includes an end wall with an inner face 313 and an outer face 314 and a circumferential wall having an inner circumference 311 and an outer circumference 312. A shaft base 315 is formed on a central portion of the inner face 313 of the end wall.

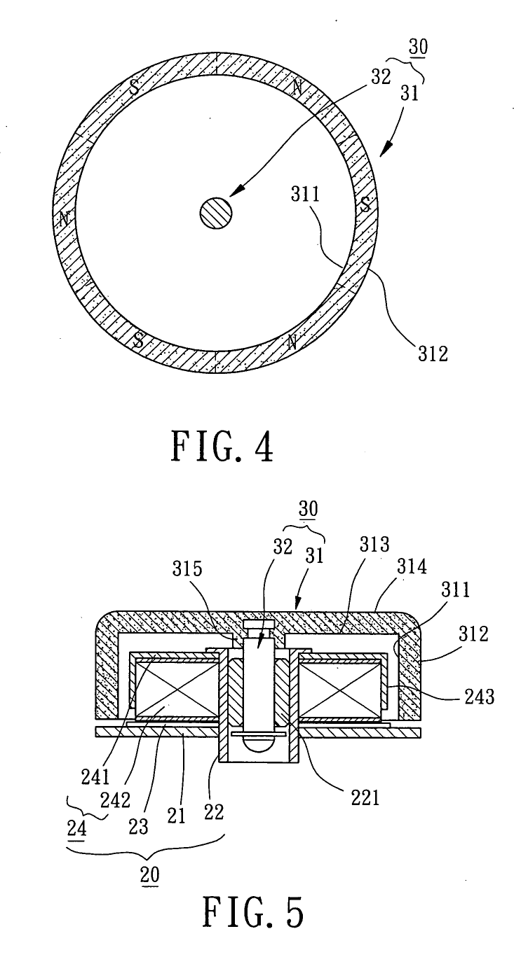

Referring to FIGS. 3 and 4, magnetization can be carried out on at least one of the surfaces of the magnetic hub 31. For example, radial magnetization is carried out on the inner circumference 311 and/or the outer circumference 312 of the magnetic hub 31 such that the magnetic powders in the inner circumference 311 and/or the outer circumference 312 are paramagnetically aligned. A plurality of alternately disposed north pole zones N and south pole zones S are thus provided. The remaining portion (the inner face 313 and the outer face 314) of the magnetic hub 31 is not magnetized such that the magnetic powders in the remaining portion is not paramagnetically aligned. In other words, the remaining portion does not possess effective north pole zones and south pole south zones with sufficient magnetic forces.

Still referring to FIGS. 2 through 4, the shaft 32 is made of metal or alloy. An end of the shaft 32 is embedded in the shaft base 315 of the magnetic hub 31. More specifically, the end of the shaft 32 is placed in a mold (not shown) for forming the magnetic hub 31 before injection molding. Thus, the end of the shaft 32 is reliably embedded in the shaft base 315 of the magnetic hub 31 after injection molding.

Referring to FIG. 5, after integral formation of the rotor 30, the rotor 30 can be mounted to a fixed portion 20 to form an external rotor type motor. The fixed portion 20 is of a conventional design and comprises a base 21, an axle tube 22, a circuit board 23, and a stator 24. At least one bearing 221 is received in the axle tube 22.

The stator 24 may include a conventional radial winding or axial winding for an external rotor type motor. Further, the stator 24 includes at least one pole plate 241 and at least one winding 242. The pole plate 241 is bent at an outer edge thereof to form at least two pole faces 2343 facing the inner circumference 311 of the magnetic hub 31 of the rotor 30.

In operation, the north pole zones N and the south pole zones S on the inner circumference 311 of the magnetic hub 31 induce alternating magnetic fields created by the pole faces 243 to drive the rotor 30 to turn. Since the magnetic hub 31 of the rotor 30 in accordance with the present invention is a hub and possesses magnetic characteristics, an additional magnetic ring or member is not required for the rotor 30. The structure of the external rotor type motor is simplified, the manufacturing process thereof is shortened, and the manufacturing cost thereof is cut. Further, the radial size and the axial size of the rotor 30 can be reduced, which is advantageous to miniaturization of the external rotor type motor.

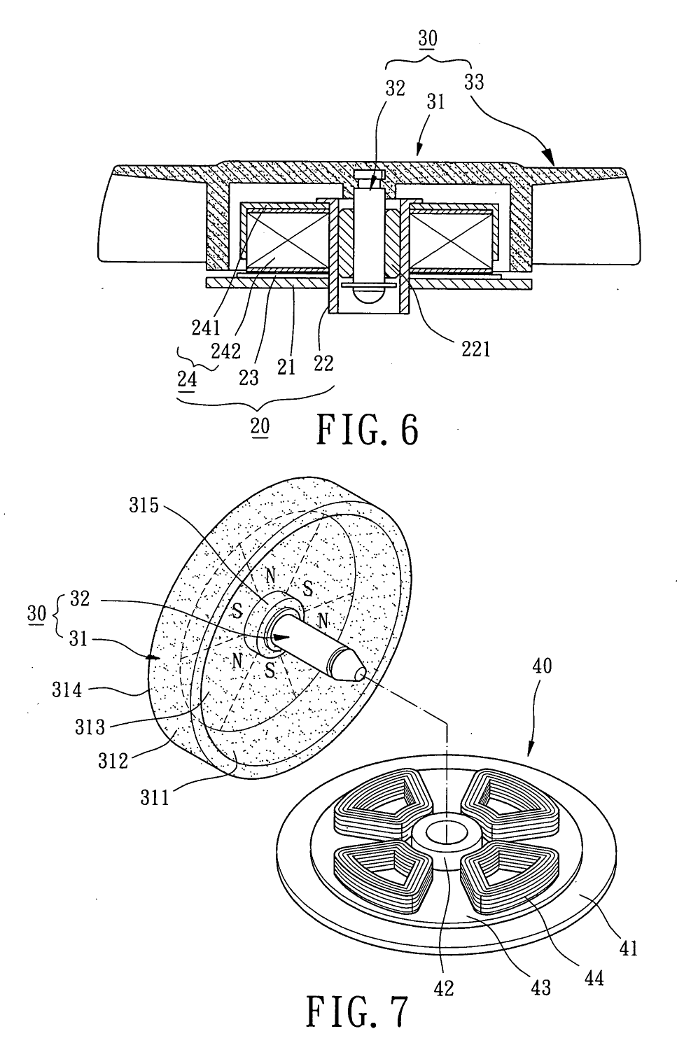

FIG. 6 illustrates a second embodiment of the invention, wherein a plurality of blades or vanes 33 are integrally formed on the outer circumference 312 of the magnetic hub 31 of the rotor 30. The vanes 33 are also made of a plastic matrix and magnetic powders. In other words, the vanes 33 are made of a plastic magnet. Thus, the rotor 30 and the fixed portion 20 together form a basic structure for a heat-dissipating fan. The structure of the heat-dissipating fan is simplified, the manufacturing process thereof is shortened, and the manufacturing cost thereof is cut. Miniaturization of the heat-dissipating fan can be achieved.

FIG. 7 illustrates a third embodiment of the invention, wherein axial magnetization is carried out on the inner face 313 and/or the outer face 314. A plurality of alternately disposed north pole zones N and south pole zones S are thus provided. The rotor 30 is mounted to a fixed portion 40 for a disk type (or flat type) motor. The fixed portion 40 includes a base 41, an axle tube 42, a circuit board 43, and a stator 44 having a plurality of axial energizing windings that face the inner face 313 of the magnetic hub 31 of the rotor 30.

In operation, the north pole zones N and the south pole zones S on the inner face 313 of the magnetic hub 31 induce alternating magnetic fields created by the axial energizing windings of the stator 44 to drive the rotor 30 to turn. The magnetic hub 31 and the fixed portion 40 together form a basic structure for the disk type motor. The structure of the disk type motor is simplified, the manufacturing process thereof is shortened, and the manufacturing cost thereof is cut. Miniaturization of the disk type motor can be achieved.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A motor rotor comprising:
a magnetic hub made of a plastic matrix and magnetic powders, the magnetic hub having a central portion, the magnetic hub including a plurality of surfaces, at least one of the surfaces of the magnetic hub including a plurality of alternately disposed north pole zones and south pole zones; and
a shaft including an end fixed to the central portion of the magnetic hub.

2. The motor rotor as claimed in claim 1, wherein the magnetic hub is formed by injection molding.

3. The motor rotor as claimed in claim 1, wherein the magnetic hub comprises an inner circumference that is radially magnetized to form the north pole zones and south pole zones.

4. The motor rotor as claimed in claim 1, wherein the magnetic hub comprises an outer circumference that is radially magnetized to form the north pole zones and south pole zones.

5. The motor rotor as claimed in claim 1, wherein the magnetic hub further comprises a plurality of integrally formed vanes.

6. The motor rotor as claimed in claim 1, wherein the magnetic hub comprises an inner face that is axially magnetized to form the north pole zones and south pole zones.

7. The motor rotor as claimed in claim 1, wherein the magnetic hub comprises an outer face that is axially magnetized to form the north pole zones and south pole zones.

8. A motor rotor comprising:
a magnetic hub made of a plastic matrix and magnetic powders, the magnetic hub including an end wall and a circumferential wall, the end wall having an outer face and an inner face with a central portion, the circumferential wall having an inner circumference and an outer circumference, at least one of the inner face, the outer face, the inner circumference, and the outer circumference of the magnetic hub including a plurality of alternately disposed north pole zones and south pole zones; and
a shaft including an end fixed to the central portion of the magnetic hub.

9. The motor rotor as claimed in claim 8, wherein the magnetic hub is formed by injection molding.

10. The motor rotor as claimed in claim 8, wherein the magnetic hub further comprises a plurality of integrally formed vanes on the outer circumference.
